(19) United States
(12) Patent Application Publication
(10) Pub. No.: US 2005/0038958 A1
(43) Pub. Date: Feb. 17, 2005

(54) Disk-array controller with host-controlled NVRAM

(76) Inventors: Mike Jadon, Los Angeles, CA (US); Robert Lercari, Sun Valley, CA (US); Richard M. Mathews, Northridge, CA (US); William R. Peebles, Simi Valley, CA (US); Phap Nguyen, Reseda, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/824,851

(22) Filed: Apr. 14, 2004

Related U.S. Application Data
(60) Provisional application No. 60/494,696, filed on Aug. 13, 2003.

(51) Int. Cl. G06F 12/00

(52) U.S. Cl. 711/114; 711/170; 711/113

(57) ABSTRACT

A host-NVRAM disk-array controller that can be connected to a host computer. The controller including an NVRAM, a plurality of disk array controllers, and a plurality of busses. The NVRAM is connected to a memory controller (together called the NVRAM device). The host computer has the ability to directly control the NVRAM device. The plurality of busses connect the NVRAM device and the disk array controllers.

### CROSS-REFERENCE TO RELATED APPLICATION

Priority is claimed under 35 U.S.C. § 119(e) to U.S. Provisional Patent Application No. 60/494,696, filed on Aug. 13, 2003, entitled “Memory Card and Related Methods for Using It” by Mike Jadon, which is incorporated by reference herein.

### TECHNICAL FIELD OF THE INVENTION

The present invention relates generally to peripheral controllers for data storage. More particularly, it relates to enhancing synchronous I/O operations to disk-array controllers.

### BACKGROUND OF THE INVENTION

There is very great demand for high-speed stable storage. Disks provide stable storage, but latency and transfer times can be high.

Non-volatile random-access memory (NVRAM) can be use to improve performance in a number of ways to improve response time and data reliability in server appliances. NVRAM may consist of random-access memory that does not require power to retain data or Dynamic Random-Access Memory (DRAM) or Synchronous DRAM (SDRAM) that has secondary power such as battery or an external universal power supply (UPS).

One such prior-art application is shown in FIG. 1. The host computer 11 may write important data to disks 17. When time is critical, it may instead store data to the faster NVRAM device 12. The DMA memory controller 18 manages the NVRAM 19 and provides direct memory access (DMA) services. DMA is used to transfer data in either direction between host memory 15 and NVRAM 19 across an industry-standard peripheral component interconnect (PCI) bus 13. DMA performs transfers while the host computer 11 performs other operations, relieving the host computer 11 of those duties. The data stored in NVRAM 19 may be a cache of data that will eventually be written to disks 17, a journal of changes to the disks 19 that may be replayed to recover from a system failure but which never needs to be written to disks 17, or other information about transactions that may eventually be processed causing related data to be written to disks 17.

This application allows the host computer 11 to directly control the NVRAM device 12, but it does not allow the NVRAM 19 to be used together efficiently with the disks 17. Data moving from NVRAM to disk must pass through the primary bus 13. This can reduce performance because the bus must be shared with other device transactions. Another disadvantage of this scheme is that NVRAM device 12 requires its own location on the primary bus 13 rather than sharing one with the controller for the disks 17. Locations on the bus often are not easily made available.

FIG. 2A shows a prior-art implementation in which NVRAM is attached to a storage device. The host computer 100 is attached to a disk controller 101 by an interface 104, possibly a PCI bus. The disk controller is attached to a disk or other storage device 102. The interface 105 may be a local bus such as Small Computer System Interface (SCSI) or AT-attached (ATA). The disk 102 may also be replaced by an intelligent storage device such as network-attached storage (NAS) or a storage area network (SAN) device. In this case interface 105 may be a network or fibre channel connection. The NVRAM 103 is under complete control of the disk or storage device 102. The host computer 100 has no way to access the NVRAM contents using interface 105.

FIG. 2B is similar to FIG. 2A except that the NVRAM 203 has moved to the disk controller 201. The disk controller may manage disks 202 as a JBOD (Just a Bunch of Disks) or a RAID (Redundant Array of Independent Disks) system. When the host computer 200 makes a request to the disk controller 201, the controller may choose to cache data in the NVRAM 203. Management of the NVRAM is the responsibility of the disk controller. This includes algorithms for deciding when data cached in NVRAM will be transferred to disk and when it will be discarded.

The solutions in FIGS. 2A and 2B solve the problem of keeping the NVRAM data close to the disks, but they take control of the NVRAM away from the host computer. Usually the host computer has a much better idea of how data is being used than does the disk or the disk controller. The host can know if data is temporary in nature and never needs to be copied to disk. The host can know if the data is likely to be modified again soon and thus disk accesses can be reduced if the data is not immediately copied to disk. The host can know if data will no longer be needed and can be removed from cache once it is on disk.

There are other prior art applications that utilize bus bridges. These bus bridges often include local memory that is a subset of the bridge. FIG. 3 illustrates a host computer 250 that connects to one or more devices 252 through a PCI bus bridge. Information on PCI bus 254 is forwarded by the bridge 251 to PCI bus 255 as necessary to reach the target device 252. Information on PCI bus 255 is forwarded by the bridge 251 to PCI bus 254 as necessary to reach the host computer 250. The PCI bridge 251 may use local bridge memory 253 temporarily to store the data that flows through the bridge. Data coming from bus 254, for example, may be stored in the bridge's memory until bus 255 is available and device 252 is ready to receive the data. This memory is used by the PCI bridge 251 to make its routing function more efficient. There is no way for the host computer 250 to directly control this memory, specifically where the bridge 251 puts this data or when it is removed from memory 253. From the perspective of the host computer 250, it is writing the data directly to the device 252 except for a time delay in having the data reach the device. While the present invention utilizes some of these same bus bridge devices with associated local memory, it should be noted that the local bus bridge memory 253 is a subset of the bridge that is transparent to the host computer. This is unlike NVRAM 19 in FIG. 1 or NVRAM 309 in FIG. 4, which are endpoint devices that can be directly controlled by the host computer.

Accordingly, it is an object of the present invention to provide NVRAM that may be fully controlled by the host computer.

Another object of the present invention is to provide NVRAM and disk controllers connected by private data paths while allowing each to run on its bus at as high a speed as possible.

Another object of the present invention is to provide NVRAM and disk controllers that may share a single connection to the host computer's primary bus.

### SUMMARY OF THE INVENTION

The present invention combines NVRAM under control of the host computer with disk array controllers close to the NVRAM. Unlike many disk/RAID controllers that have a processor that takes control of the NVRAM, the present invention leaves the NVRAM to be used by the host. A plurality of private buses is used in the present invention to allow the host computer to program the NVRAM and disk array controllers to transfer data directly between themselves. Either the disk array controllers or the NVRAM controller may act as DMA masters.

### BRIEF DESCRIPTION OF THE DRAWINGS

FIG. 1 is a block diagram of a prior art PCI NVRAM device.

FIG. 2A illustrates a prior art disk device or storage device that includes NVRAM.

FIG. 2B illustrates a prior art disk controller or RAID controller that includes NVRAM.

FIG. 3 illustrates a prior art PCI bridge with SDRAM.

FIG. 4 is a block diagram of a preferred embodiment of the invention.

FIG. 5 is a flow chart for allocating NVRAM.

FIG. 6 is a flow chart for scheduling writes to disk.

FIG. 7 is a flow chart for choosing whether to keep data in NVRAM.

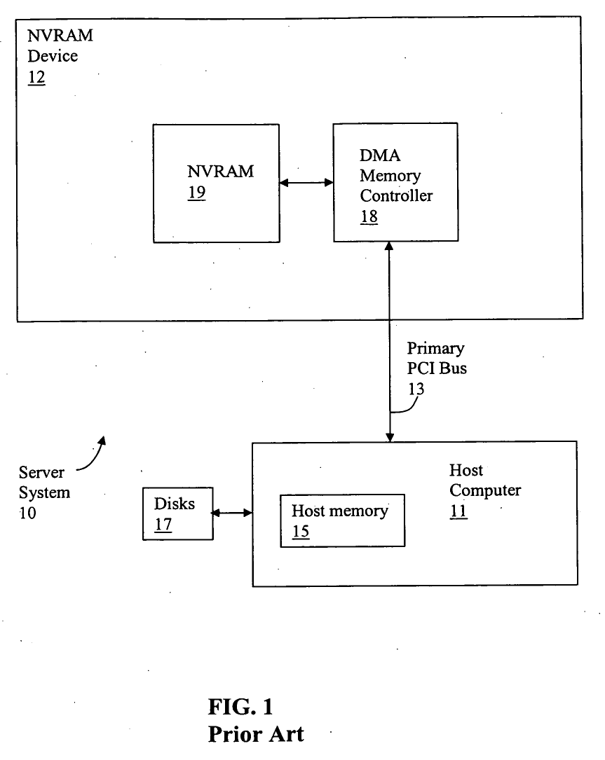

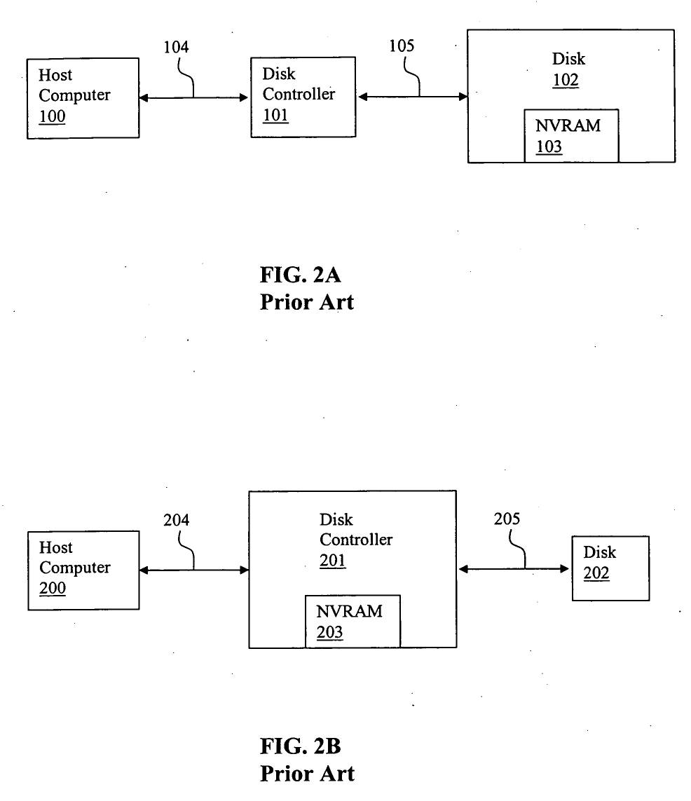

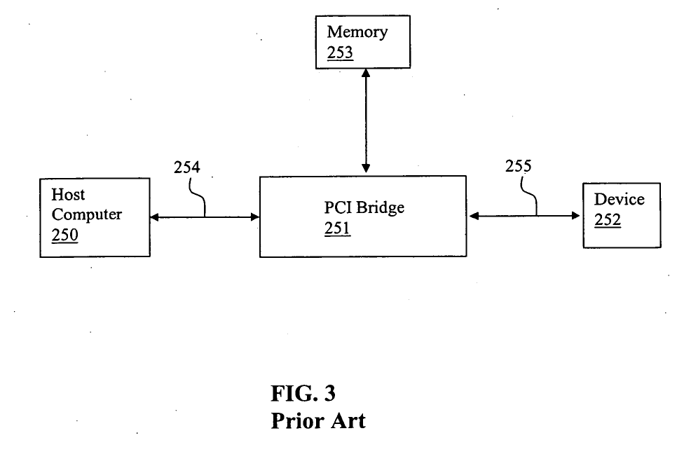

### DETAILED DESCRIPTION OF THE INVENTION

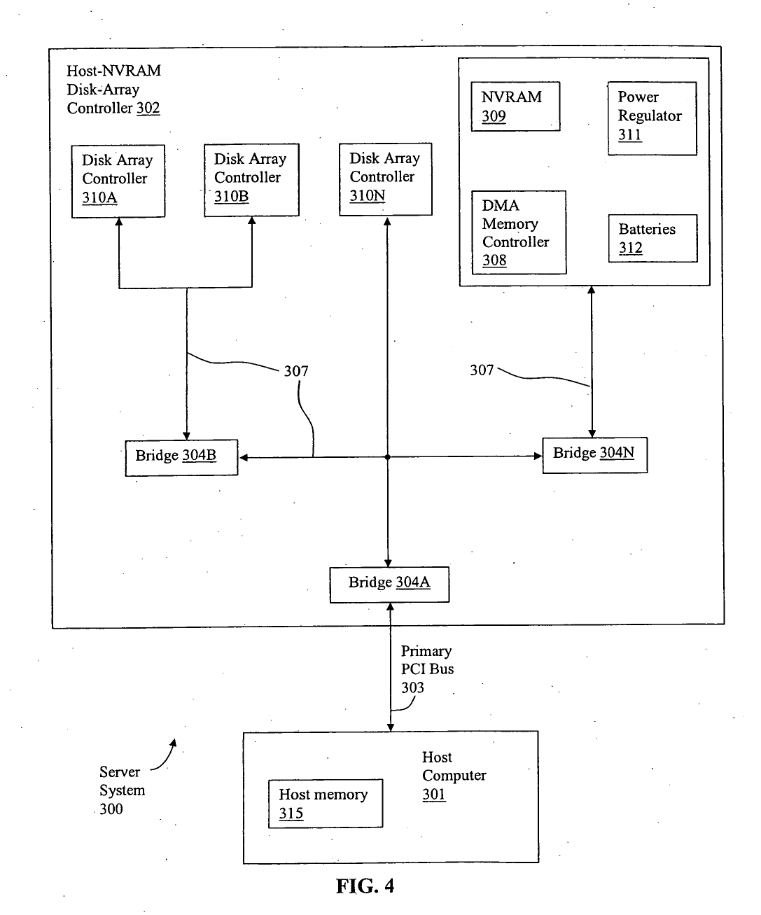

FIG. 4 illustrates a preferred embodiment of the invention incorporated into a Server System 300. The Host Computer 301 includes a Primary PCI Bus 303, though other bus technologies may be used. Attached to the bus 303 is the Host-NVRAM Disk-Array Controller 302. Within this controller 302 are a plurality of local PCI buses 307, though again it is understood that other bus technologies may be used.

A plurality of PCI bridges 304A, 304B, through 304N connects the various buses. The bridges are used to meet load requirements on each bus that limit the number of devices that may be attached to the bus. The bridges also may be used to connect buses of different technologies or different speeds. For example, some devices on the controller 302 may use the PCI 2.2 specification while others use the PCI-X 2.0 specification.

A plurality of disk-array controllers 310A, 310B, through 310N are attached to the plurality of PCI buses 307. In the preferred embodiment these are SCSI controllers or multi-port Serial ATA (SATA) controllers.

The DMA memory controller 308 manages the NVRAM 309. The NVRAM may consist of memory that requires no power to maintain data (such as magnetic memory), battery-backed SDRAM, or other RAM that uses external power. The preferred embodiment shown uses either power from the host computer 301 or rechargeable batteries 312, with a power regulator 311 managing the delivery of power to the NVRAM and to the battery recharge circuit.

The memory controller 308 includes DMA master capabilities that allow direct memory transfers between NVRAM 309 and host memory 315 or between NVRAM 309 and the plurality of disk array controllers 310 via one or more of the plurality of buses 307. The host computer 301 controls the NVRAM 309 and may program the DMA memory controller 308.

The NVRAM 309 may also be accessed as a target by either the host computer 301 or the disk array controllers 310. This allows NVRAM to be used as ordinary memory. Unlike cache on a disk or disk controller, this allows it to be accessed one byte at a time rather than in large blocks. The entire NVRAM may be mapped into the address space of the bus, though in the preferred embodiment only a window into NVRAM is mapped. A register in the NVRAM controller 308 determines which window is visible.

The host can use any method for caching data to NVRAM. The advantage of the present invention is being able to keep the host's cache close to the disk controllers. Because the host controls the cache, it can determine what data is to be cached, when the cached data is to move to or from the disk controllers, and when it can be freed.

Because the NVRAM cache appears to the host as ordinary memory, the host can access individual bytes of data in the cache. On the other hand, prior art disk-based cache must generally be accessed in blocks of 512 bytes or larger.

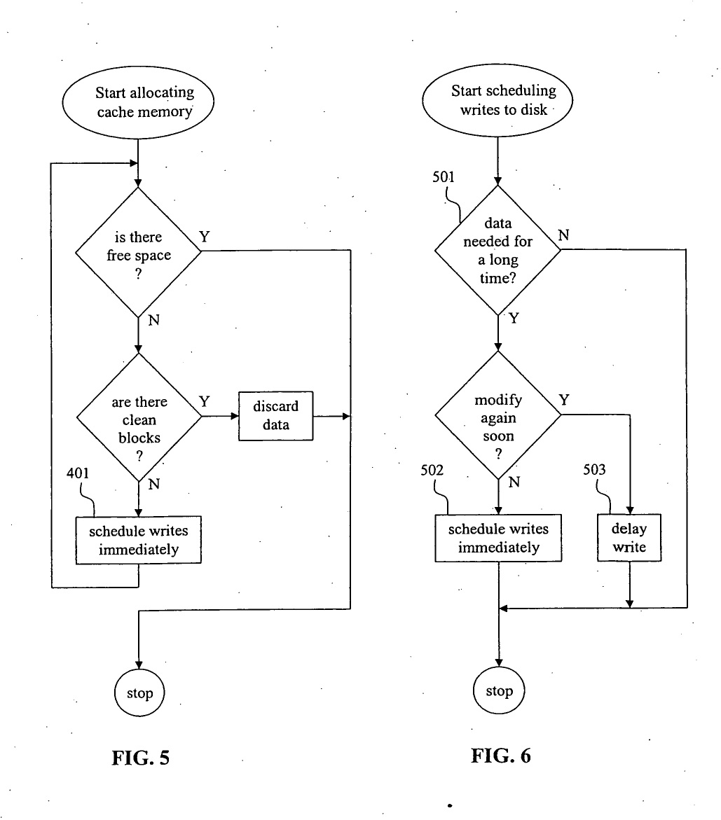

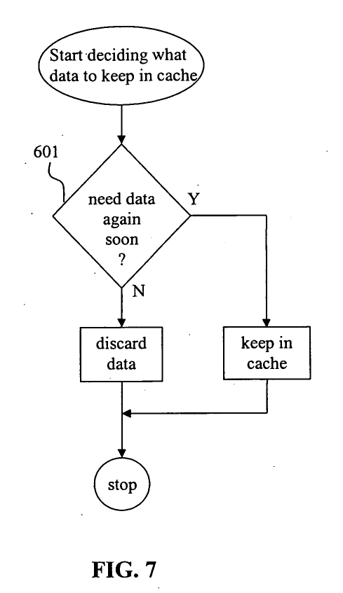

FIGS. 5 through 7 illustrate typical algorithms that may be used to manage a cache. The advantage of the present invention is that the host computer 301 is able to make these decisions rather than a disk or disk controller. In a preferred embodiment of the invention, the host computer 301 would allocate memory from the NVRAM 309 (FIG. 5). On boot of the host computer, it would recognize data already allocated in the NVRAM. Data that needs to be stored quickly can be written to NVRAM. In some cases, such as data from a file system journal, the data may be expected to become obsolete in a short time, as determined in step 501. In such a case, the host computer 301 may never send the data to disks. The host may schedule other data that needs to be kept for a long time to be transferred to disk. If the host does not expect the data to be used again or modified again soon, the host may choose to do the transfer immediately, as in step 502. For other types of data, the host may choose to delay the transfer to disk, as in step 503. When writes are delayed, it may be desirable not to do the write until it is necessary to free space in step 401. Once the data is on disk, if it is determined in step 601 that the data is not likely to be needed again soon, the NVRAM can be freed; otherwise, the NVRAM may remain available for the host to read the data faster than from disk. When data needs to be read from storage system, the host will also recognize when copies of the data are still in NVRAM and thus the data can be retrieved more quickly than going to disk.

The preferred embodiment will include storing file system journals to NVRAM that are never transferred to disk. It will include storing file system changes in NVRAM in which the same data is modified frequently such as access time on files or changes associated with creating or deleting large numbers of files. The host computer will send these changes to disk less frequently, but the changes will be preserved in stable storage in the NVRAM. The preferred embodiment will include saving transactions in NVRAM even before processing is complete on incorporating the transactions into complex databases or other files. It will also include using NVRAM to create a checkpoint of data on disk, with all updates going only to NVRAM while the disk contents are copied such as when creating a backup.

The methods above are not by themselves new. The advantage of the present invention is that the host computer 301 is better able to make each of the decisions involved than the disk or disk controller. The host retains control of these decisions while having the convenience of having the data stored close to the disk controllers. Applying these methods to a host-controlled cache rather than a disk-controlled cache provides advantages in performance.

1. A host-NVRAM disk-array controller that can be connected to a host computer, the controller comprising:
an NVRAM connected to a memory controller (together called the NVRAM device), the host computer having the ability to directly control the NVRAM device;
a plurality of disk array controllers;
a plurality of buses connecting the NVRAM device and the disk array controllers.

2. A device of claim 3, wherein the memory controller can act as a DMA master.

3. A method for using the controller of claim 2, the method comprising of the host computer programming the NVRAM controller as a DMA master for transferring data between host memory and NVRAM.

4. A method for using the controller of claim 1, the method comprising of transferring data directly between NVRAM and the disk array controllers using DMA on the memory controller or on the disk array controllers.

5. A method for using the controller of claim 1, the method comprising of the host computer performing steps:
allocating memory from NVRAM or recognizing during booting that the memory was previously allocated;
optionally writing or updating data in NVRAM from host memory;
optionally scheduling data transfers from NVRAM to the disk array controllers;
optionally scheduling data transfers from the disk array controllers to NVRAM;
optionally reading data from NVRAM to host memory;
freeing memory from NVRAM with or without first writing to the disk array controllers.

6. A device of claim 1, wherein there is only one disk controller.

7. A device of claim 1, wherein the memory controller is on a separate bus from the disk controllers to allow it to operate at a different speed and using a different bus protocol.

8. A device of claim 7, wherein the NVRAM controller is on a PCI 2.2 bus and the disk controllers are on faster PCI-X buses.

9. A device of claim 1, wherein the buses used are Conventional PCI, PCI-X, and PCI Express buses.

10. A device of claim 1, wherein the disk controllers are SCSI controllers.

11. A device of claim 1, wherein the disk controllers are SATA controllers.

12. A device of claim 1, wherein the disk controllers are Fibre Channel controllers.

13. A device of claim 1, wherein the NVRAM is battery-backed SDRAM.

14. A device of claim 1, wherein the NVRAM can operate from external power.

15. A device of claim 1, wherein the NVRAM can preserve data without any power.
